(19) United States
(12) Patent Application Publication
(10) Pub. No.: US 2020/0249673 A1
(43) Pub. Date: Aug. 6, 2020

(54) Systems and Methods for Obtaining and Using Location Data

(71) Applicant: National Geospatial-Intelligence Agency, Springfield, VA (US)

(72) Inventor: Joseph Fleishman, Charlottesville, VA (US)

(73) Assignee: National Geospatial-Intelligence Agency, Springfield, VA (US)

(21) Appl. No.: 16/264,018

(22) Filed: Jan. 31, 2019

(51) Int. Cl. G05D 1/00; G05D 1/02; G06K 7/14; G06K 19/06

(52) U.S. Cl. CPC G05D 1/0088; G05D 1/021; G05D 1/0206; G06K 19/06065; G06K 7/1417; G06K 19/06037; G05D 1/0202

(57) ABSTRACT

Systems and methods for obtaining location data and associated information, including dynamic navigation and relative location information. A system links location, navigation, schematic, and other related data to 2D and/or 3D patterns printed on, attached to, printed in, or otherwise embedded in items. These patterns are detected by readers contained in devices such as cell phones, PDAs, tablets, drones, robots, vehicles, or construction equipment. Pattern-specific data can then be combined with position and orientation information associated with vehicles, machines, and equipment, including relative position information. System information can be used to inform and notify of events, update or verify relative and absolute positions of system components, and for other purposes.

### BACKGROUND

Global Positioning Satellite (GPS) technology has become an integral part of our daily lives: telling us where we are, where we can find the places and things that interest us, and helping us navigate between locations. However, GPS signals are not always accessible or available. GPS devices rely on a user having a relatively clear path between the user and multiple satellites. Buildings, parking garages, and other urban features frequently interfere with GPS signal reception, as do tunnels and geographic features such as mountains, canyons, and dense forests. Human activity, including ubiquitous technologies that emit electromagnetic radiation, can also degrade the usefulness of GPS technology.

For the above reasons and more, GPS signals do not uniformly provide a level of location accuracy that is suitable to the user. For example, GPS-based car navigation systems can be inaccurate by several feet, which may result in faulty directions, missed turns, and other annoyances. These same difficulties are increased when using GPS technology to navigate on foot or perform other tasks that require a tighter tolerance than +/−several feet. GPS signals may also be deliberately blocked or manipulated (sometimes referred to as “spoofing”) by malicious actors. Numerous media reports exist of aircraft and ships being lured off course by GPS spoofing. There are also reports of terrorist groups using GPS jamming technology to defeat military UAVs.

### SUMMARY

The following presents a simplified summary of the disclosure in order to provide a basic understanding to the reader. This summary is not an extensive overview of the disclosure and it does not identify key/critical elements or delineate the scope of the specification. Its sole purpose is to present a selection of concepts disclosed herein in a simplified form as a prelude to the more detailed description that is presented later.

As used herein, the term “includes” and its variants are to be read as open terms that mean “includes, but is not limited to.” The term “based on” is to be read as “based at least in part on.” The term “one embodiment” and “an embodiment” are to be read as “at least one embodiment.” The term “another embodiment” is to be read as “at least one other embodiment.” Other definitions, explicit and implicit, may be included below. The terms “data” and “information” may be used interchangeably, as appropriate based on the context of the disclosure.

The present application is directed to systems and methods for obtaining location data and associated information, including dynamic navigation and relative location information. Further examples of location data include the location of: items relative to a coordinate system; items relative to the earth; items relative to other items; items relative to their planned future locations; items relative to their prior locations; and one or more objects relative to one or more items.

As used throughout, an item may be any physical thing that can be physically associated with a 2D or a 3D pattern. Examples include: buildings; dams and other public works; building components; construction materials; roadway segments; parking garage components; pipe segments; industrial components; vehicles; animals; construction equipment; and fabric articles such as flags, banners, tents, canopies, curtains, and so forth.

2D and 3D patterns can be associated with items by a variety of methods, including printed on, attached to, adhered to, or otherwise affixed to, printed in, embedded in, stamped on, or encapsulated in, an item. These patterns may be detected and identified, or “read,” by readers, which may comprise one or more of a camera, radar, lidar, sonar, X-ray, or other similar device. Where a reader contains a plurality of these devices, they may or may not be co-located. The reader(s) may be contained in moveable devices such as cell phones, PDAs, tablets, drones, robots, vehicles, and construction equipment. Alternatively, or in addition, the reader(s) may be space-based and may be mobile or stationary relative to a position on the earth or in space.

To obtain useful location information, position and orientation information associated with the reader is combined with data associated with the pattern being read. Further information can be obtained by linking this data with other data that is associated with one or more other patterns read by the reader. The position and orientation information may include: 1) the position and orientation of the reader relative to the pattern, 2) position and orientation information relative to the one or more other patterns, 3) position and orientation information obtained from other sensors associated with the reader, or 4) any other appropriate information. Data associated with one or more patterns may be combined with data from the reader using wired or wireless communication technologies.

The systems and methods disclosed in the present application can be used to obtain real-time navigation information for piloted and autonomous vehicles in GPS-denied or degraded areas such as underground, in dense urban areas, inside buildings and parking garages, and areas where GPS signals are subject to active or passive blocking or manipulation by malicious or unwitting actors. The present application also teaches the facilitation of autonomous navigation by providing location information with greater precision and a lower electro-magnetic signature than GPS. Further, the application contemplates evaluating damage to structures or facilities by measuring displacement of key components. Finally, there are other uses that will become readily apparent to one of ordinary skill in the art.

In one embodiment, a 2D pattern is printed or stamped onto a sticker affixed to an item. The location data associated with the sticker may be established before or after the sticker is affixed.

In one embodiment, a 2D pattern is printed, engraved (including via laser), or stamped onto a tag affixed to an item. The tag may be made of metal, paper, wood, plastic, fiberglass, concrete, or any suitable material and attached using one or more staples, nails, wire, or any other suitable method. The location data associated with the pattern may be established before or after the tag is affixed.

In one embodiment, a 2D pattern is printed, engraved (including via laser), or stamped directly onto an item. The location data associated with the pattern may be established before or after it is printed, engraved, or stamped.

In one embodiment, a 3D pattern is printed, engraved (including via laser), or stamped onto a sticker affixed to an item. The location data associated with the sticker may be established before or after the sticker is affixed. The depth of the sticker may be based on, or independent of, the 3D pattern.

In one embodiment, a 3D pattern is printed, engraved (including via laser), or stamped onto a tag affixed to an item. The tag may be made of metal, paper, wood, plastic, fiberglass, concrete, or any suitable material and attached using one or more staples, nails, wire, or any other suitable method. The location data associated with the pattern may be established before or after the tag is affixed.

In one embodiment, a 3D pattern is printed, engraved (including via laser), or stamped directly onto an item. The location data associated with the pattern may be established before or after it is printed, engraved, or stamped.

In one embodiment, a 3D printer is used to fabricate an item and a 3D pattern is incorporated into the item as part of the printing process. The location data associated with the 3D pattern may be established before or after the item is printed.

In one embodiment, a 3D printer is used to fabricate a sticker, tag, mold, part, or other object comprising a 3D pattern incorporated into the tag, mold, part, or other object as part of the printing process. The location data associated with the 3D pattern may be established before or after the tag, mold, part, or other object is printed. In the case of a sticker, the adhesive may be applied after printing or as part of the printing process.

In one embodiment, formwork for forming concrete, metal, fiberglass, foam, plastics, or other appropriate materials has one or more depressions and/or openings into which molds of 2D or 3D patterns are inserted, such that the item formed in the formwork has the 2D or 3D pattern from the mold embedded in the formed item. The location data associated with the 2D or 3D pattern may be established before or after the item is formed.

In one embodiment, formwork for forming concrete, metal, fiberglass, foam, plastics, or other appropriate materials has one or more depressions and/or openings into which molds comprising 2D or 3D patterns are inserted such that the item formed in the formwork has the mold embedded in the formed item. The mold(s) may have studs, hooks, or other fasteners attached to it to facilitate bonding between mold and formed item. The location data associated with the 2D or 3D pattern may be established before or after the item is formed.

In one embodiment, the 2D or 3D pattern may be—or may comprise material that is—printed, stamped, formed, painted, or otherwise made readable in wavelengths outside the visible spectrum.

In one embodiment, the 2D or 3D pattern may comprise material that is more or less dense than material surrounding the pattern.

In one embodiment, the 2D or 3D pattern may be woven or otherwise incorporated into one or more layers of an item.

In one embodiment, the 2D or 3D pattern may be obscured or covered by another material or object, or otherwise rendered undetectable to the naked human eye.

In one embodiment, the reader comprises one or more of: a depth camera, IR camera, UV camera, color (RGB) camera, CCD camera, CMOS camera, thermal camera, light intensity camera, hyperspectral camera, any other suitable type of camera, radar, lidar, sonar, X-ray, or any other device capable of capturing light or distance data. The reader may comprise combinations of different data capture device types, a plurality of data capture devices of the same type, or any other suitable combination of data capture device types.

In one embodiment, the reader is a stand-alone hand-held data capture device.

In one embodiment, the reader is physically attached to another hand-held object.

In one embodiment, the reader is part of or attached to a mobile device including, a cell phone, PDA, tablet, laptop, or other portable electronic device.

In one embodiment, the reader is part of or attached to an unmanned vehicle, such as an aerial drone, surface or submersible watercraft, or unmanned ground vehicle.

In one embodiment, the reader is part of or attached to a robot such as an inspection robot or any other appropriate type of remote-controlled, pre-programmed, or autonomous device.

In one embodiment, the reader is part of a manned vehicle such as a car, truck, plane, helicopter, or surface or submersible watercraft.

In one embodiment, the reader is part of or attached to a piece of equipment, such as: an inspection vehicle, platform, boom, or other similar object or system; a crane, forklift, backhoe, dump truck, grader, bulldozer, or other similar piece of equipment; a piece of formwork, including reusable formwork, pre-stressing and/or post-tensioning beds, slip forms, paving machines, concrete mixers, concrete pumps, concrete finishing devices, rollers, compactors, vibrators, and other similar pieces of equipment; equipment for moving materials or objects, including conveyors, carts, belts, elevators, chutes, jacks, bridge jacking systems, other appropriate types of equipment, and systems comprising these types of equipment; and any other appropriate piece of equipment.

In one embodiment, the reader is attached to an item. In such an embodiment, the reader may be arranged such that it can read the pattern associated with the item in addition to other patterns associated with other items, as discussed further below.

In one embodiment, the reader is attached to a 3D printer. The printer may be generally stationary or movable under its own or external power.

In one embodiment, the reader is in communication with a computing device. The computing device may be a mobile computing device, server, stand-alone device, networked device, or other appropriate device or system. The computing device may be in communication with a storage device, including a cloud-based storage device or any appropriate storage device.

In one embodiment, the reader is in communication with a storage device. The storage device may be a cloud-based storage device or any appropriate storage device.

In one embodiment, data obtained by the reader is combined with data located at a computing or storage device. This combined data can be used to generate or update data related to a location of a reader and/or item, including navigation data, relative location data, and/or data related to other readers and/or items.

In one embodiment, any of the connections between any of the reader, computing device, and/or storage device may be wired connections or wireless connections.

In one embodiment, data obtained by the reader is compared against data located at a computing or storage device in order to determine any differences that may exist between the data obtained by the reader and associated data located at the computing or storage device.

In one embodiment, data obtained by the reader is combined with or compared against data located at a computing or storage device in order to at least partially control the operation of a mobile or stationary 3D printer, robot, manned or unmanned vehicle, piece of equipment, or any other object or item that the reader may be attached to or associated with.

In one embodiment, data obtained by the reader is combined with or compared against data located at a computing or storage device in order to provide feedback to a user. This feedback may be used to orient and/or direct the user and/or assist the user in operating a mobile or stationary 3D printer, robot, manned or unmanned vehicle, piece of equipment, or any other object or item that the reader may be attached to or associated with.

In one embodiment, data obtained by the reader is combined with or compared against data associated with an augmented reality system.

Many of the attendant features will be more readily appreciated as the same becomes better understood by reference to the following detailed description considered in connection with the accompanying drawings.

### DESCRIPTION OF THE DRAWINGS

The present invention will be better understood from the following detailed description, read in light of the accompanying drawings, wherein:

FIG. 1 is an illustration of a 2D pattern printed on a sticker affixed to an item;

FIG. 2 is an illustration of a 2D pattern printed on a tag affixed to an item such that its position is fixed relative to the item;

FIG. 3 is an illustration of a 2D pattern printed on a tag affixed to an item such that its position is not fixed relative to the item;

FIG. 4 is an illustration of a 2D pattern printed directly on an item;

FIG. 5 is an illustration of a 3D pattern printed on a sticker affixed to an item;

FIG. 6 is an illustration of a 3D pattern printed on a tag affixed an item such that its position is fixed relative to the item;

FIG. 7 is an illustration of a 3D pattern printed on a tag affixed to an item such that its position is not fixed relative to the item;

FIG. 8 is an illustration of a 3D pattern printed directly on an item;

FIG. 9 is an illustration of a 3D pattern placed on a layer of material and surrounded by a material;

FIG. 10 is a flow chart of a method for printing an item with a 3D pattern;

FIG. 11 is a flow chart of a method for printing an item with a 3D pattern;

FIG. 12 is an illustration of a cross-section of an item printed with a 3D pattern embedded in the item;

FIG. 13 is an illustration of a pattern that is woven into one or more fabric layers;

FIG. 14 is an illustration of formwork having an opening into which molds of 2D or 3D patterns are inserted such that the item formed in the formwork has the 2D or 3D pattern from the mold embedded in the formed item;

FIG. 15 is an illustration of formwork having a depression into which molds comprising 2D or 3D patterns are inserted such that the item formed in the formwork has the mold embedded in the formed item;

FIG. 16 is an illustration of a system comprising a reader, computing device, and an optional storage device;

FIG. 17 is an illustration of a reader in communication with a storage device;

FIG. 18 is a flow chart of a method for combining data obtained by a reader with data located at a computing or storage device in order to generate or update data related to an item and optionally notify a user of the generated or updated data;

FIG. 19 is a flow chart of a method for comparing data obtained by a reader against data located at a computing or storage device in order to determine any differences that may exist between the data obtained by the reader and associated data located at the computing or storage device and optionally notify a user of a determined difference;

FIG. 20 is a flow chart of a method for obtaining data by a reader, combining or comparing the obtained data against data located at a computing or storage device, generating instructions based on the data, and sending those instructions to a device for execution;

FIG. 21 is a flow chart of a method for obtaining data by a reader, combining or comparing the obtained data against data located at a computing or storage device, generating feedback for a user based on the data, providing the feedback to the user, and optionally causing the user to respond to the feedback;

FIG. 22 is a flow chart of a method for combining data obtained by a reader with data located at a computing or storage device in order to generate or update data related to an item and send the data to or have the data accessed by an augmented reality system; and

FIG. 23 is an illustration of various components of an exemplary computing-based device.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples. Further, various illustrated or described portions of processes may be re-ordered or executed in parallel in various different embodiments.

Although a particular example may be described and illustrated herein as comprising either a 2D pattern exclusively or a 3D pattern exclusively, the examples are provided as an example and not a limitation. As those skilled in the art will appreciate, any of the examples may be implemented with either a 2D or 3D pattern, or a combination thereof.

Further, although some of the examples provided may not contain features described with regard to another example, such a description is provided as an example and not a limitation. As those skilled in the art will appreciate, any of the features associated with an example may be incorporated into any other example provided without departing from the scope of the disclosure.

As used herein, the terms “visible” and “transparent” refer to the subject being visible or invisible to the naked human eye. The term “visible spectrum” refers to the range of the electro-magnetic (EM) spectrum that is visible to the naked human eye. The term “non-visible spectrum” refers to the range of the EM spectrum that is not visible to the naked human eye.

At least one embodiment of the present application is directed to systems and methods for obtaining location and associated information, including dynamic navigation and relative location information. A system links relative and/or absolute location information and other related data to one or more 2D and/or 3D patterns printed on, printed in, or otherwise embedded in or attached to one or more items. These patterns are detected by readers contained in devices such as cell phones, PDAs, tablets, drones, robots, vehicles, watercraft, aircraft, construction equipment, and space-based platforms. Position and orientation information associated with the device, including information related to the device's position relative to the pattern being read and/or another pattern, is combined with the data linked to the pattern being read in order to update and/or verify information associated with the item associated with the pattern and/or the device and/or the reader.

As used herein, location data includes the location and, optionally, the orientation of, at least one object or item. Absolute and relative location information includes, but is not limited to, the location of: items relative to a coordinate system; items relative to the earth; items relative to other items; items relative to their planned locations; items relative to their prior locations; and one or more other objects relative to one or more items.

Data related to the item may include: attempts by other readers to access the data, including the absolute or relative timing of those attempts and whether or not they were successful; attempts by the same reader or other readers to read other 2D or 3D patterns, including sorting or filtering the attempts based on physical distance or time elapsed from the current reading; information relating to construction of the item associated with the 2D or 3D pattern, such as design drawings, as-built drawings, shop drawings, construction tolerances, camber data, design and construction loads, Building Information Management (BIM) data; and other data as known in the art.

As used herein, 2D and 3D patterns refer to patterns that are created in two or three physical dimensions, respectively. Physical dimensions include length, width, and height (also referred to as dimensions along an x, y, or z axis in a local or global coordinate system). Changes in color are not considered one of the physical dimensions. For example, a 2D pattern may be created using an object that is uniform in width but whose depth varies along its length (x is constant while z varies based on y). Another example of a 2D pattern may be created using an object that is uniform in height but varies in width along its length. This object may be a different density or hyperspectral reflectivity from its surroundings in order to enable detection by a reader. To illustrate: a simple 3D pattern may be a “chess board” where at least one square is at a different height relative to the other squares. A similar example is a “pie” where at least one “slice” is at a different height than the other slices. Notwithstanding these examples, a 3D pattern may be any shape where a z dimension varies according to x and y position.

Any relative or absolute depth, distance, measurement, orientation, and/or position referred to herein may be determined by any one or more of: manual human measurement, as with a ruler, tape measure, measuring wheel, compass, transit, theodolite, stadia, and the like; IR, UV, RGB, and thermal camera systems, including stereoscopic cameras, time of flight systems, phase shift systems, light intensity systems including shuttered light pulse imaging, and structured light systems; laser, microwave, and similar range finding systems; radar, lidar, X-ray, and sonar systems; GPS systems; accelerometers, tilt meters, gyroscopes, and other motion sensors; velocity measuring systems; and any other known appropriate measurement system or technique or combination thereof.

Any 2D or 3D pattern may be made readable in the non-visible spectrum by coating the pattern in or forming the pattern from one or more materials that are detectable in the non-visible spectrum. This effect may be accomplished by: coating or forming the pattern in or from a material that is sensitive to non-visible wavelengths, such as IR or UV; coating or forming the pattern in or from a material that possesses a different thermal reflectivity than its surrounding material; forming the pattern from a material that has a different density than its surroundings; coating or forming the pattern such that it is distinguishable from its surroundings (any item that is not part of the pattern) using spectroscopy; or any other known, appropriate method. Where the pattern is created in a fabric, the techniques above may be applied to certain fibers, threads, or other elements of the fabric to create the pattern.

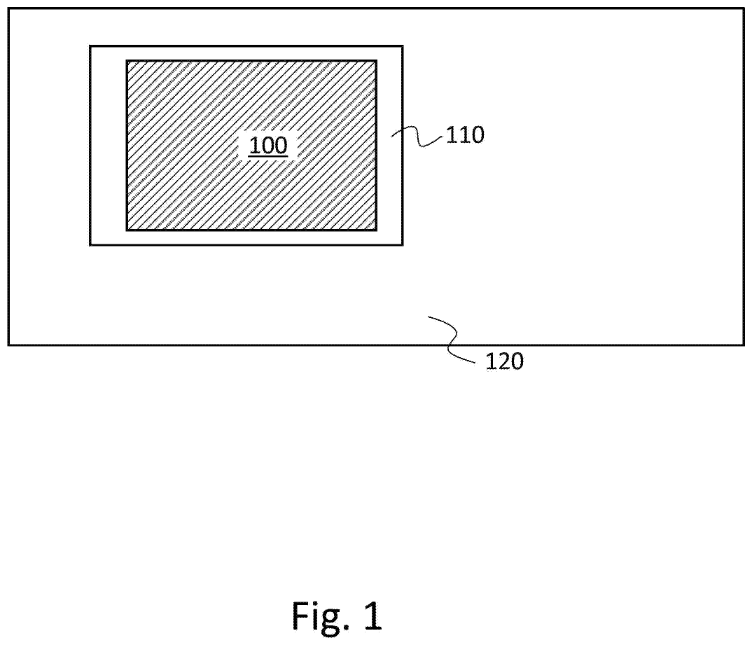

FIG. 1 is an illustration of a 2D pattern 100 printed or stamped onto a sticker 110 affixed to an item 120. The pattern 100 may be printed or stamped using ink that is either visible or transparent in the visible spectrum and may have a different thermal reflectivity than the sticker 110 in order to facilitate pattern detection and/or recognition. This may also reduce pattern visibility to an end user where the sticker 110 is either transparent in the visible spectrum or designed to blend in with the item 120. The pattern 100 may also be printed or stamped using ink that is visible or transparent in the visible spectrum and readable in the non-visible spectrum. In embodiments where the pattern is transparent in the visible spectrum, it may be placed in standard location to aid in locating the pattern. Reducing pattern visibility may be desirable in conflict zones or other areas where there is a risk that the pattern may be defaced or destroyed. It may also be desirable in situations where a visible pattern would detract from its surroundings, cause a user to become distracted, or otherwise inconvenience a user or other person.

The location data associated with a sticker may be established before or after the sticker is affixed. The location data may be determined by manually measuring the location relative to a known point on the item 120 or relative to any other known local or global point, including relative to a survey marker. The location data may also be determined through semi-automated measurement such as by using a hand-held or otherwise manually operated device capable of automatically detecting measurements or by having a user manually position the item 120 relative to a fixed scanner. The location may also be determined through fully-automated measurement such as through a system that controls the location of the item 120 and the measuring system. The fully-automated and semi-automated systems may incorporate various known techniques including robotic handling and automated conveyor systems for moving item 120 and/or controlling its movement and/or positioning along up to three axes of rotation and/or translation.

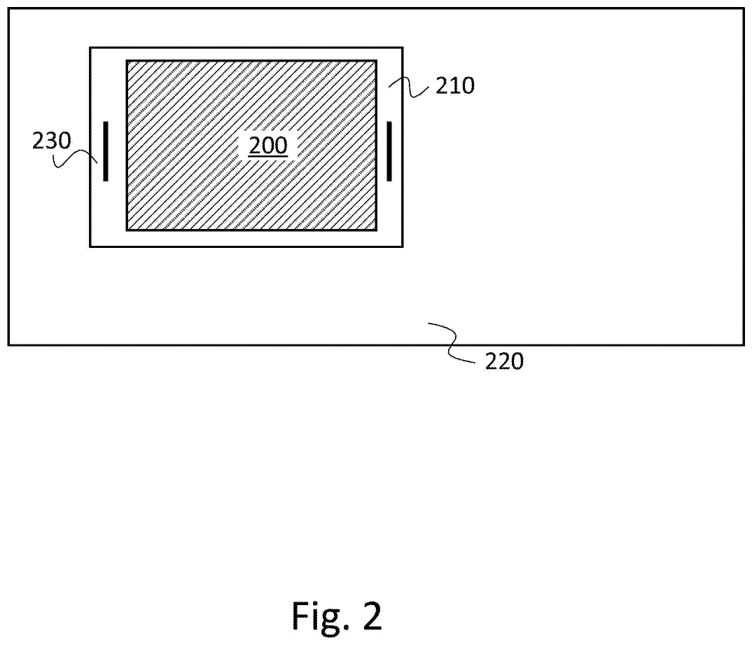

FIG. 2 is an illustration of a 2D pattern 200 printed on a tag 210 stapled 230 to an item 220 such that its position is fixed relative to the item. The tag 210 may be made of metal, paper, wood, plastic, fiberglass, concrete, or any suitable material and attached using one or more staples, nails, wire, or any other suitable method. The location data associated with the pattern may be established before or after the tag is affixed. The 2D pattern 200 may also be engraved (including via laser), or stamped onto the tag 210 affixed to the item 220.

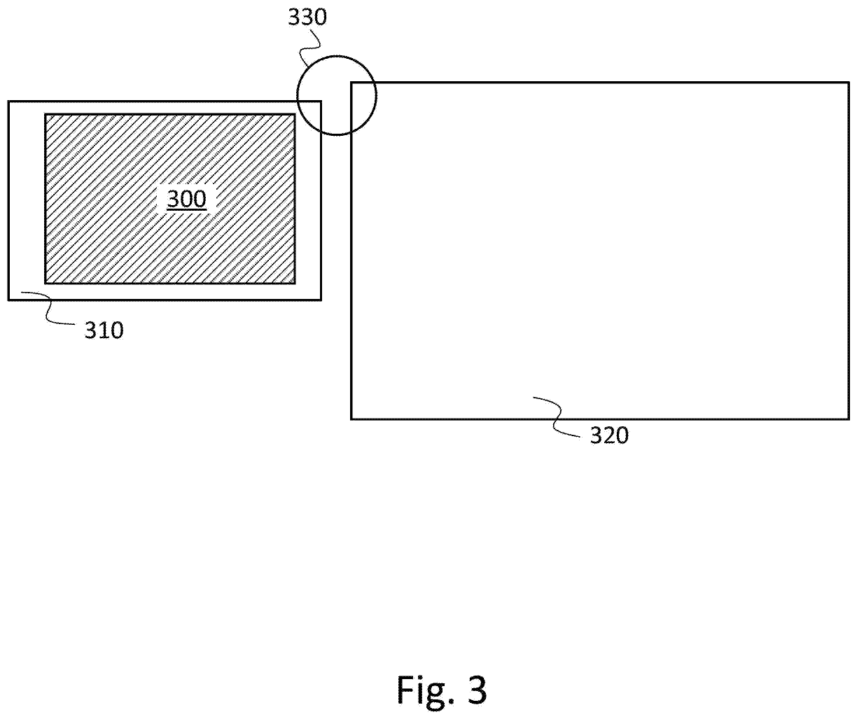

FIG. 3 is an illustration of a 2D pattern 300 printed on a tag 310 tied 330 to an item 320 such that its position is not fixed relative to the item. Similar to FIG. 2, the tag 310 may be made of metal, paper, wood, plastic, fiberglass, concrete, or any suitable material and attached using clips, nails, wire or other ties, or any other suitable method. The location data associated with the pattern may be established before or after the tag is affixed. The 2D pattern 300 may also be engraved (including via laser), or stamped onto the tag 310 affixed to the item 320. This embodiment may be more cost effective in situations where the exact location of the pattern is not needed, such as for tracking large movements/displacements, inventory control, budget and/or schedule tracking, and tracking movement of migratory or herd animals.

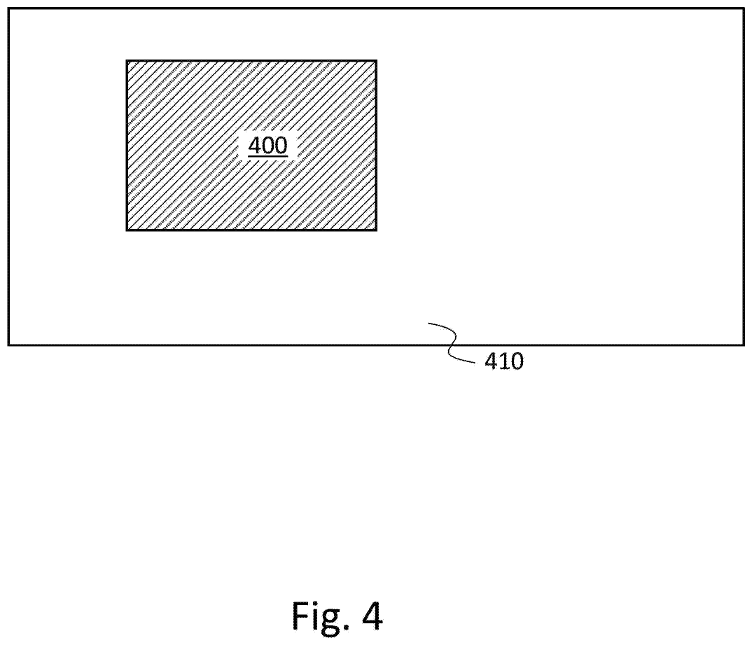

FIG. 4 is an illustration of a 2D pattern 400 printed directly on an item 410. The 2D pattern 400 may be printed, engraved (including via laser), or stamped directly onto an item 410. The 2D pattern 400 may also be printed or stamped using ink that is transparent in the visible spectrum but readable in the non-visible spectrum so that exposed surfaces, including doors, windows, shutters, siding, counter tops, light fixtures, wall panels, and other finishes, can be scanned without displaying or exhibiting a pattern that may be distracting or unappealing to an end user or occupant. The 2D pattern 400 may also be printed or stamped using ink that is transparent in the visible spectrum but has a different thermal reflectivity than the item 410 so that the pattern is invisible to an end user or occupant. In embodiments where the pattern is transparent in the visible spectrum, it may be placed in standard location to aid in locating the pattern. The location data associated with the pattern may be established before or after it is printed, stamped, or engraved.

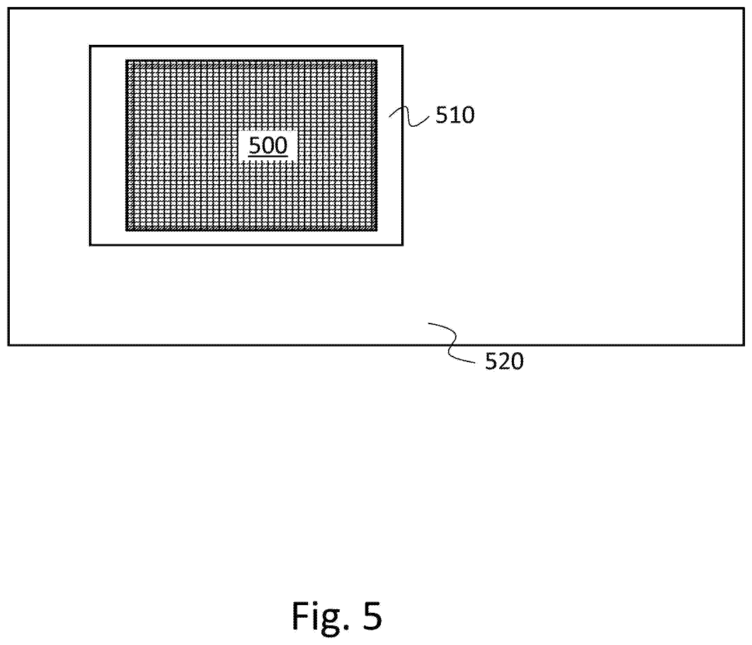

FIG. 5 is an illustration of a 3D pattern 500 printed on a sticker 510 affixed to an item 520. The 3D pattern 500 may be printed, engraved (including via laser), or stamped onto a sticker 510 affixed to an item 520. The pattern 500 and sticker 510 may also be created using 3D printing techniques, discussed further below. The location of the sticker 510 may be determined before or after the sticker 510 is affixed. The depth of the sticker 510 may be based on or independent of the 3D pattern 500. The pattern 500 may comprise a uniform depth border to allow more accurate readings of the depth of the pattern elements by comparison to the border. The pattern 500 may also or alternatively comprise a uniform depth region other than the border.

The surface of the pattern 500 to be read may comprise a different material than the rest of the pattern 500 to facilitate pattern recognition. The different material may be printed, stamped, painted, irradiated, or generated and/or applied using any known suitable method. The different material may be IR, UV, or thermal sensitive or a different color or reflectivity.

The surface of the pattern 500 to be read may also or alternatively be colored a different color than the rest of the pattern 500. The coloring may be done using any known suitable technique, including printing, stamping, or painting, and the entirety of the pattern 500 may be created from the same material.

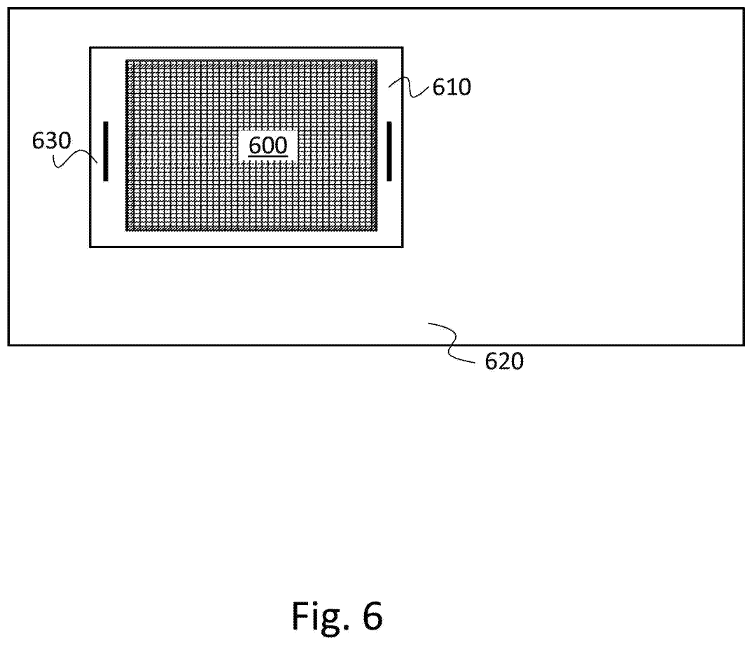

FIG. 6 is an illustration of a 3D pattern 600 printed on a tag 610 stapled 630 to an item 620 such that its position is fixed relative to the item 620. The 3D pattern 600 may be printed, engraved (including via laser), or stamped onto a tag 610 affixed to an item 620. The tag 610 may be made of metal, paper, wood, plastic, fiberglass, concrete, or any suitable material and attached using one or more staples, nails, wire, or any other suitable method. The location data associated with the pattern 600 may be established before or after the tag 610 is affixed.

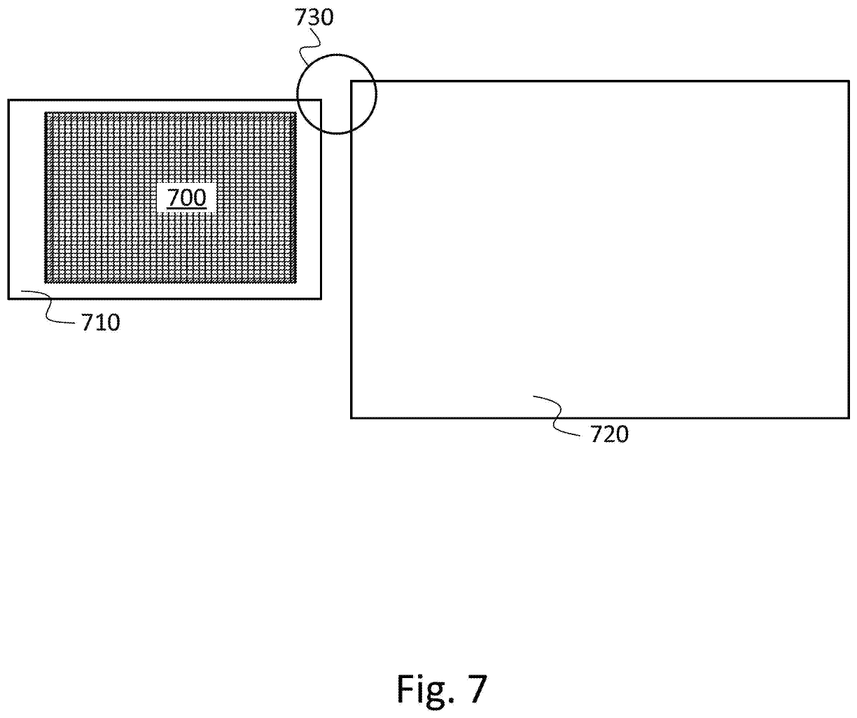

FIG. 7 is an illustration of a 3D pattern 700 printed on a tag 710 tied 730 to an item 720 such that its position is not fixed relative to the item. Similar to FIG. 3, the tag 710 may be made of metal, paper, wood, plastic, fiberglass, concrete, or any suitable material and attached using clips, nails, wire or other ties, or any other suitable method. The general location of the pattern may be determined before or after the tag is affixed. The 3D pattern 700 may also be engraved (including via laser), or stamped onto the tag 710 affixed to the item 720. This embodiment may be more cost effective is situations where the exact location of the pattern is not needed, as discussed above.

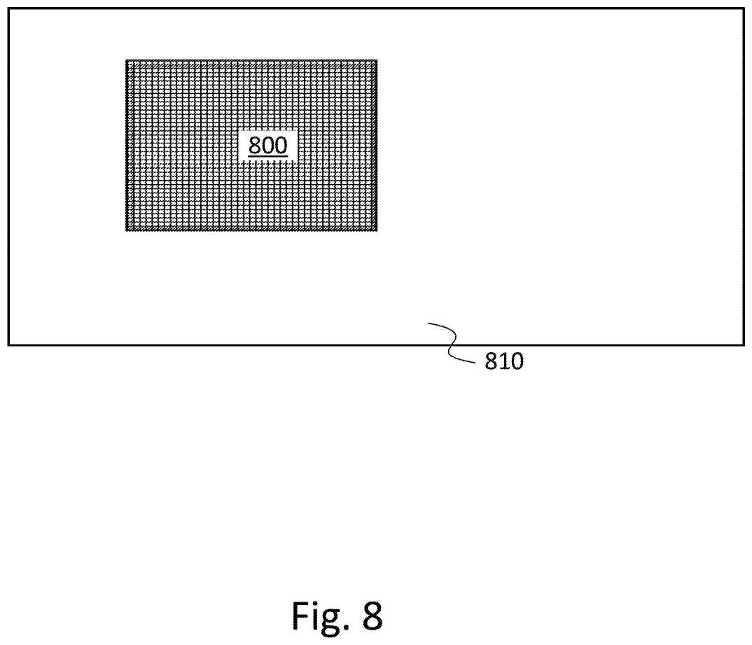

FIG. 8 is an illustration of a 3D pattern 800 printed directly on an item 810. The 3D pattern 800 may be printed, engraved (including via laser), or stamped directly onto an item 810. The surface of 3D pattern 800 to be read may also be printed or stamped using ink that is visible or transparent in the visible spectrum but readable in the non-visible spectrum to improve detection and/or readability of the pattern by creating or increasing the contrast of the pattern relative to the background, including the item. The 3D pattern 800 may also be printed or stamped using ink that is visible or transparent in the visible spectrum but has a different thermal reflectivity than the item 810 to improve detection/readability of the pattern. In embodiments where the pattern is transparent in the visible spectrum, it may be placed in standard location to aid in locating the pattern.

Similar to FIG. 5, the surface of the pattern 800 to be read may comprise a different material than the rest of the pattern 800 to facilitate pattern detection and/or recognition. The different material may be printed, stamped, painted, irradiated, or generated and/or applied using any known suitable method. The different material may be IR, UV, or thermal sensitive or a different color or reflectivity.

The surface of the pattern 800 to be read may also or alternatively be colored a different color than the rest of the pattern 800. The coloring may be done using any known suitable technique, including printing, stamping, or painting, and the entirety of the pattern 800 may be created from the same material. The location of the pattern 800 may be determined before or after it is printed, stamped, or engraved.

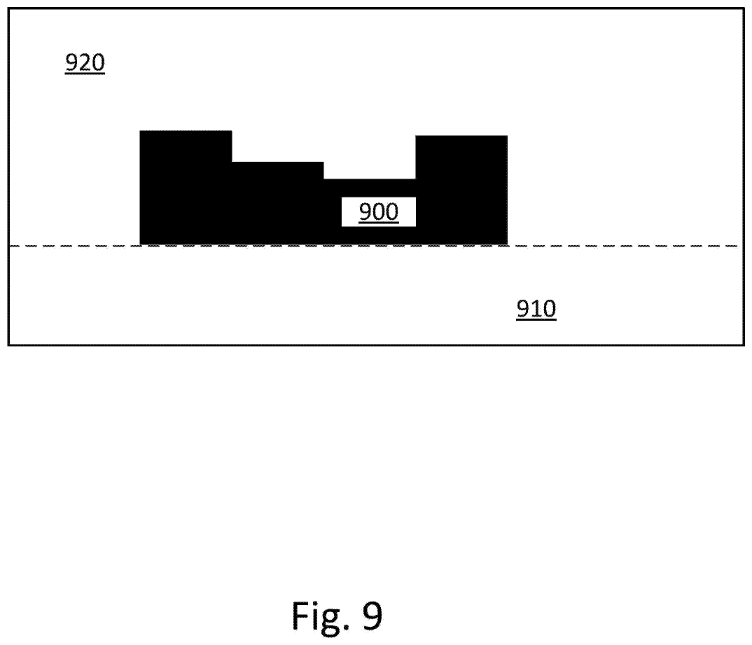

FIG. 9 is an illustration of a 3D pattern 900 placed on a layer of material 910 and surrounded by a material 920. Material 910 and material 920 may or may not be the same material. Pattern 900 may be made of a material with a higher or lower density than material 920 and material 910. Pattern 900 may be arranged to be read from more than one side (i.e. top and bottom, inside and outside, and the like) and may be read using any suitable form of radar, sonar, ultrasound, or similar technology, including ground penetrating radar systems. The location of the 3D pattern 900 may be determined before or after material 920 is placed.

One embodiment of this technique is the incorporation of patterns into a roadway. In such an embodiment, a base or sub-base layer may be laid, and the pattern may be fixed to it. After the pattern is fixed to the base or sub-base layer, another layer (such as an asphalt or Portland cement concrete layer) may be poured or formed on top of and around the pattern.

Another embodiment may be realized in pouring pre-stressed concrete beams, such as those used in a parking garage. In this embodiment, the pattern may be fixed in the formwork (either attached to rebar, a foam core, a previous pour or lift, or some other item within the form) and have concrete poured around it.

This type of placement of the 3D pattern can be beneficial for objects that may be subject to wind or other fluid flow, drag or other friction or friction-like forces, or objects where a smooth surface may be desired for other functional or aesthetic purposes. Examples of surfaces where this type of pattern emplacement may be beneficial include, but are not limited to: roofs and walls of buildings and other structures; sidewalks, roadways, and other paved surfaces; gutters, canals, and other drainage systems; gas and fluid distribution pipes or conduits; electrical and/or utility conduits; bridge decks, girders, beams, and abutments; and sport courts, such as tennis, roller hockey, and basketball courts.

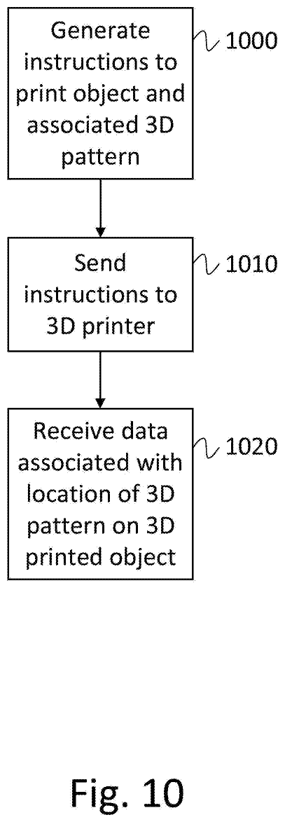

FIG. 10 is a flow chart of a method for printing an object with a 3D pattern. A 3D printer may be used to fabricate an object with a 3D pattern incorporated into the object as part of the printing process. The object may be an item, a sticker or tag to be attached to an item, a mold to form or create another object, or any other suitable object. Instructions to print an object and an associated 3D pattern are generated 1000 either by a user or automatically. The instructions are then sent 1010 to a 3D printer. Steps 1000 and 1010 may be performed by the same system or by two or more separate systems. Where two or more separate systems are used, the systems may be connected: directly, via wired and/or wireless connection; or via a wired and/or wireless network such as a LAN, WAN, or the internet. Alternatively, the two or more systems may be disconnected from each other such that the instructions must be physically transferred between the two or more systems (i.e., via CD, DVD, diskette, memory stick, SD card, and the like). In an embodiment comprising more than two systems, the more than two systems may comprise more than one system for generating instructions 1000, more than one 3D printer, or more than one of both.

The 3D printer may be any 3D printer capable of printing an object of the type and size specified in the instructions 1000. The 3D printer may be capable of printing an object using multiple materials, including materials that are readable in the non-visible spectrum, as discussed above. If the object being printed is a sticker, the adhesive may be applied as part of the printing process or as a separate process. The location of the 3D pattern may be determined and received 1020 by one or more of the one or more systems after the object is printed in order to improve the accuracy of the pattern's location relative to the rest of the object.

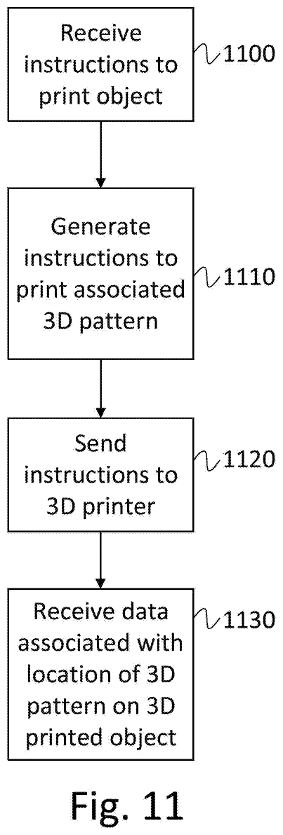

FIG. 11 is a flow chart of a method for printing an item or object with a 3D pattern. Instructions to print an item or object may be received 1100 by a system. A system may then generate 1110 instructions to print a 3D pattern associated with the item or object. The associated 3D pattern may be printed as part of the item or as a separate object to be attached to the item. The instructions are then sent 1120 to a 3D printer. The location of the 3D pattern may be determined and received 1130 by one or more of the one or more systems after the item or object is printed in order to improve the accuracy of the pattern's location relative to the rest of the item or object. Steps 1100-1130 may be performed by the same system or by two or more separate systems.

The 3D printer contemplated in the methods discussed above may also be used to print a 2D pattern. That is, an item or object may be printed using one material and a 2D pattern may be printed as part of the item or object using a different material.

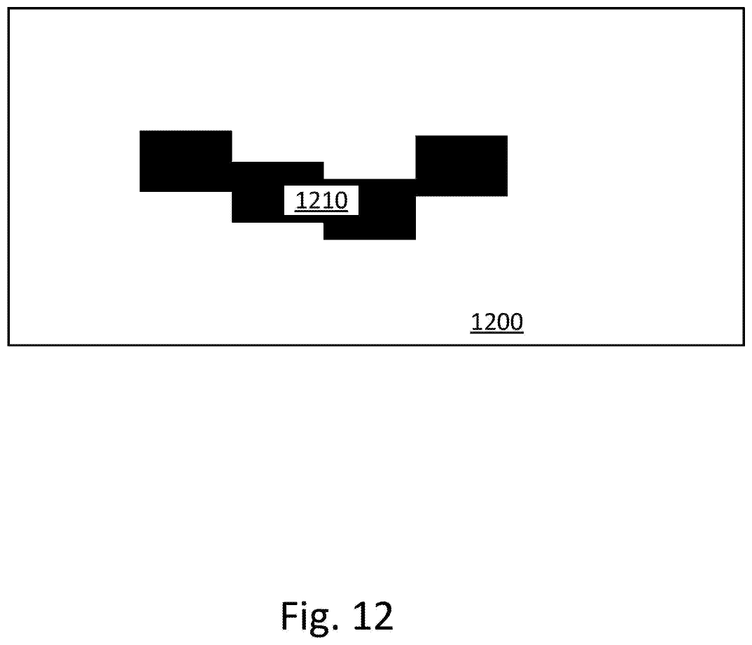

If the item or object being printed has a pattern printed with a material of a different density than the rest of the item or object, the pattern may be partially or completely surrounded by the material of the rest of the item or object. FIG. 12 is an illustration of a cross-section of an item 1200 with a 3D pattern 1210 completely surrounded by the material of the rest of the item. A 3D pattern surrounded by the material of the rest of the item may be arranged to be read from more than one side of the item (i.e. top and bottom, inside and outside, and the like) and may be read using any suitable form of radar, sonar, ultrasound, or similar technology, including ground penetrating radar systems. The location of the 3D pattern may be determined after the item or object is printed in order to improve the accuracy of the pattern's location relative to the rest of the item or object.

Similar to the discussion above, this type of placement of the 3D pattern can be beneficial for objects that may be subject to wind or other fluid flow, drag or other friction or friction-like forces, or objects where a smooth surface may be desired for other functional or aesthetic purposes. Examples of surfaces where this type of pattern emplacement may be beneficial include, but are not limited to: roofs and walls of buildings and other structures; sidewalks, roadways, and other paved surfaces; gutters, canals, and other drainage systems; gas and fluid distribution pipes or conduits; electrical and/or utility conduits; bridge decks, girders, beams, and abutments; and sport courts, such as tennis, roller hockey, and basketball courts. Additionally, a 3D pattern surrounded by the material of the rest of the object may also be formed without 3D printing. That is, the pattern may be formed using any known technique and then the material of the rest of the object may be poured, formed, packed, extruded, adhered, attached, affixed, applied, or otherwise placed around the 3D pattern, similar to the method discussed above.

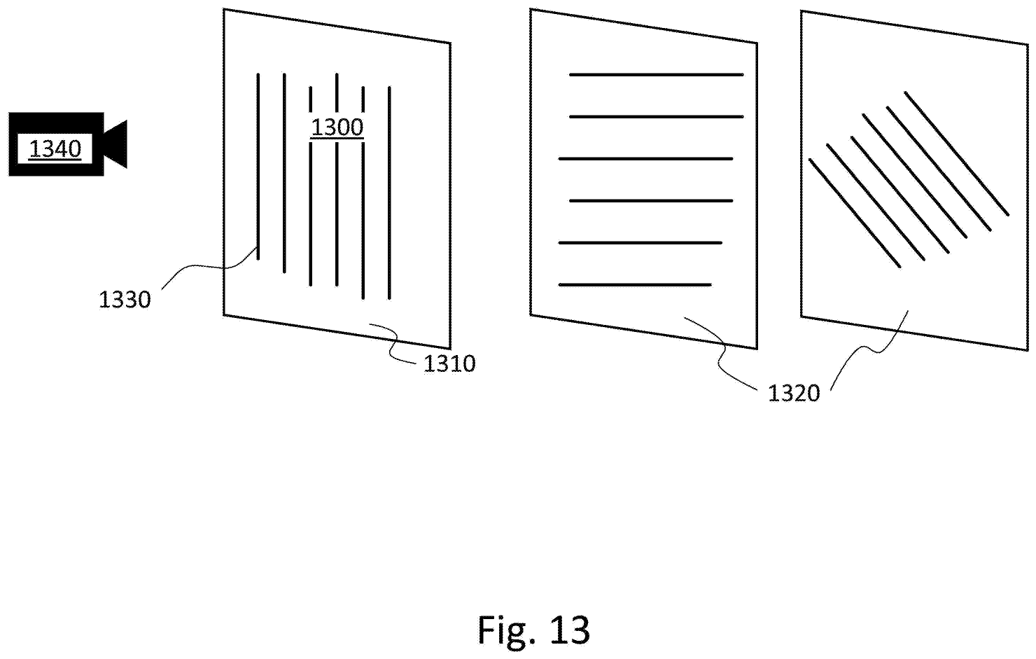

FIG. 13 is an illustration of a pattern 1300 that is woven into a fabric layer 1310 and, optionally, additional fabric layers 1320. The use of one layer creates a 2D pattern, while the additional one or more fabric layers give the option of creating a 3D pattern. The pattern 1300 is created by weaving threads 1330 into the fabric that have a different color, density, or thermal or other properties than the threads in the rest of the fabric layer 1310. These different threads 1330 are woven to create a pattern 1300 that may be read by a reader 1340 in the visible spectrum and/or the non-visible spectrum. Although the term “thread” is used in the above and following descriptions, it is understood that this technique may be used with any appropriate item in lieu of thread without departing from the spirit of the disclosure.

One embodiment of this technique may be to weave a pattern using thread that is IR reflective into a fabric with low IR reflectivity. This may be desirable when using camouflage fabrics since the pattern will be readable without detracting from the camouflage.

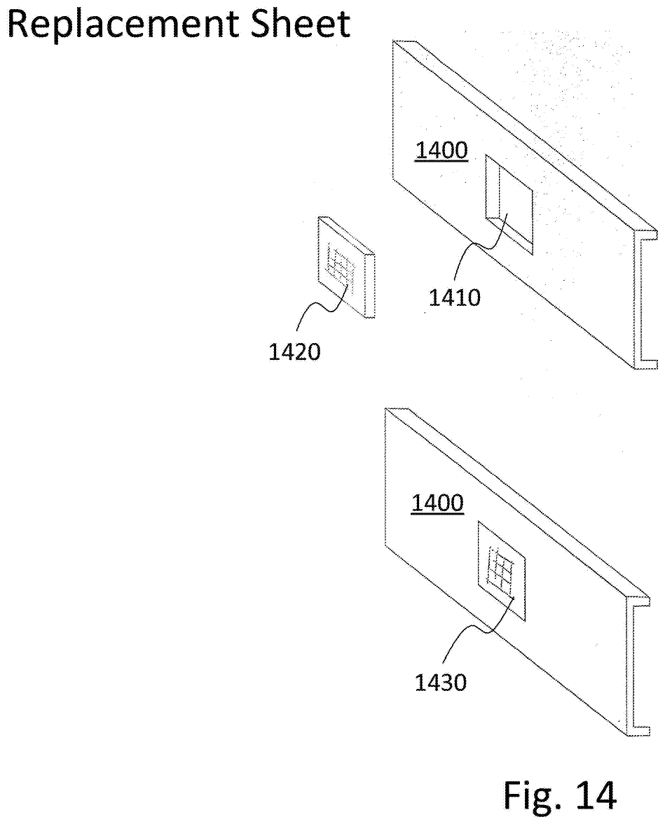

FIG. 14 is an illustration of formwork 1400 having an opening 1410 into which a mold 1420 of a 2D or 3D pattern is inserted 1430 such that the item formed in the formwork 1400 has the 2D or 3D pattern from the mold 1420 embedded in the formed item. The item may be formed from concrete, metal, fiberglass, foam, plastics, or any other appropriate material. Additionally or alternatively, the formwork 1400 may have a depression into which a mold 1420 may be inserted. That is, the mold 1420 may be accessible from more than one side of the formwork 1400, or only accessible from the side of the formwork 1400 where the material to be formed is placed. The formwork 1400 may have one or more openings and/or depressions so that multiple patterns may be formed in the item. The mold 1420 may be attached to the formwork 1400 using pins, latches, bolts, hinges, or any other appropriate method. The location of the 2D or 3D pattern may be determined before or after the item is formed.

One or more molds 1420 may be replaced after one or more items have been formed, such that at least some of a plurality of items formed have different patterns formed in them. Alternatively, or in addition, one or more molds 1420 may be used on multiple items such that each of the items has at least one pattern identical to each of the other items. This can be beneficial for determining a change in position of the formwork 1400 relative to the item during repeated forming (i.e., as part of a QA/QC program) or for monitoring movement of objects relative to each other. Formwork used for slip-forming may comprise an opening so that a smooth mold may be periodically replaced with a mold comprising a pattern. This enables the pattern to be imparted to the item during the forming process, without impeding the progress of the slip form. Additionally, the patterns may be used to monitor the progress of the slip forming.

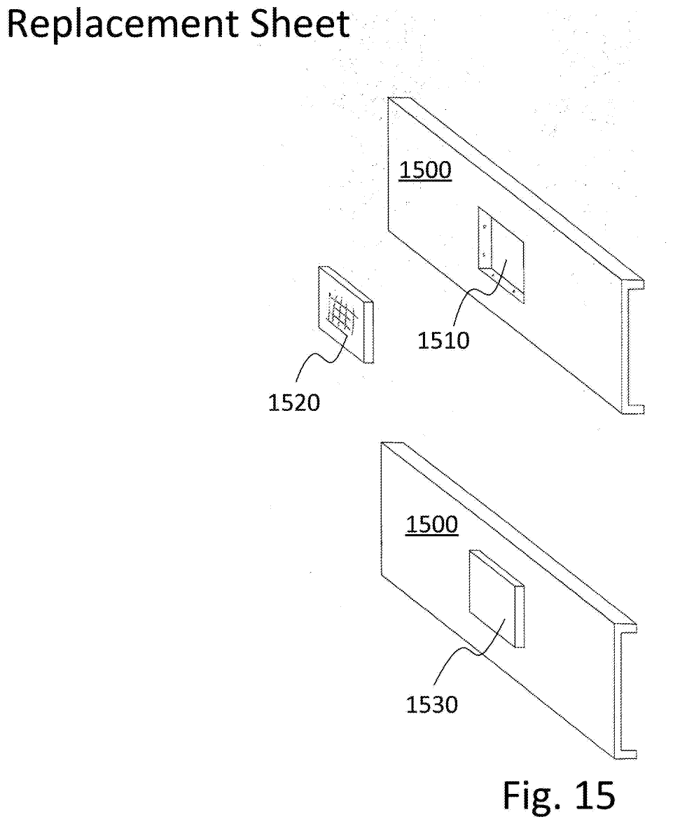

FIG. 15 is an illustration of formwork 1500 having a depression 1510 into which a mold 1520 comprising a 2D or 3D pattern is inserted 1530 such that the item formed in the formwork has the mold embedded in the formed material. The formwork 1500 may comprise one or more depressions and/or openings into which molds 1520 may be inserted. The mold 1520 may have studs, hooks, or other fasteners attached to it to facilitate bonding between the mold and the item formed in the formwork 1500. The mold 1520 may also comprise a stack of pattern sheets such that a pattern sheet is bonded to each item formed by the formwork 1500. This allows the formwork 1500 to be used multiple times before the mold 1520 runs out of pattern sheets and has to be replaced. The location of the 2D or 3D pattern may be determined before or after the item is formed.

Any of the 2D or 3D patterns discussed above may be obscured or covered by another material or object, such that the pattern is not visible to the naked human eye. A pattern may be obscured or covered by a filter that is opaque in visible wavelengths, but transparent in IR or UV wavelengths, allowing IR or UV reflective patterns to be read through the filter. Alternatively, or in addition, a pattern may be obscured or covered by a material that may appear solid and/or opaque to the naked human eye, but does not impede a radar, sonar, ultrasound, X-ray, or similar device from reading the pattern such as wallpaper or a fabric covering. These types of covering may or may not surround the pattern, as discussed above with regard to FIG. 9.

Any of the 2D or 3D patterns discussed above may be read by a reader comprising any one or more of a hyperspectral camera, depth camera, IR camera, UV camera, color (RGB) camera, CCD camera, CMOS camera, thermal camera, light intensity camera, radar, sonar, ultrasound, X-ray, or any other suitable type of camera, imaging system, or similar device. The reader may comprise combinations of different camera types, a plurality of cameras of the same type, or any other suitable combination of camera types which may or may not be co-located. The reader may also comprise multiple cameras arranged to switch from a lower-resource camera to a higher-resource camera after the presence of a pattern is detected. This may enable the reader to utilize battery, computing, bandwidth, and other resources more effectively. For example, a reader may utilize a RGB, IR, UV, or thermal camera to detect the presence of a pattern and then use a stereo camera to capture depth of the pattern. This example shows conservation of resources by not engaging in additional processing unless a pattern is detected. Other efficiencies will be appreciated by one skilled in the art.

The reader may be a stand-alone hand-held device or may be attached to another hand-held object. The reader may also be part of, or attached to, a portable electronic device such as a cell phone, PDA, tablet, or laptop. Alternatively, all or part of the reader may be fixed and arranged to read patterns associated with mobile or movable items.

All or part of the reader may be part of or attached to an unmanned vehicle, such as an aerial drone, surface or submersible watercraft, or unmanned ground vehicle. The unmanned vehicle's movements and/or actions may be remote-controlled, pre-programmed, or autonomous (i.e. one or more movements or actions are executed based on decision-making that does not require human intervention). The unmanned vehicle may also be an inspection robot. Inspection robots include remotely or autonomously-controlled machines arranged to utilize cameras and/or other sensors to evaluate and/or survey industrial facilities such as chemical and nuclear plants. Inspection robots may also be used to evaluate and/or survey pipelines and pipe networks, including by traversing the inside of one or more pipes. An inspection robot arranged to operate inside one or more pipes may be further arranged to read a 3D pattern embedded within a pipe, similar to the concept discussed above with regard to FIG. 12: the pattern is arranged to be read from the inside of the pipe, and optionally arranged to be read from the outside of the pipe and/or the edges surrounding the openings of pipe segments.

All or part of the reader may be part of or attached to a manned vehicle such as a car, truck, plane, helicopter, or surface or submersible watercraft.

All or part of the reader may be part of or attached to a piece of construction equipment, such as: an inspection vehicle, platform, boom, or other similar object or system; a crane, backhoe, dump truck, grader, bulldozer, or other similar piece of equipment; a piece of formwork for forming concrete, metals, plastics, earth, fiberglass, or any other suitable materials or combinations thereof, including reusable formwork, pre-stressing and/or post-tensioning beds, slip forms and paving machines; asphalt and portland cement concrete mixers, pumps, finishing devices, rollers, compactors, vibrators, and other similar pieces of equipment; equipment for moving materials or objects, including conveyors, carts, belts, elevators, chutes, jacks (including jacks used to move objects vertically, such as to raise a building above a foundation and jacks used to move objects horizontally, such as to move walls along a floor or to move beams and girders across their supports), bridge jacking systems, and other appropriate types of equipment; systems comprising these types of equipment; and any other appropriate piece of equipment.

All or part of the reader may be attached to a construction material, piece, part, or assembly. For example, the reader could be attached to steel members, precast (including pre and post-tensioned) concrete members, fiberglass members, or members made from other materials (wood, plastics, other composites). All or part of the reader may additionally or alternatively be attached to an assembly, sub-assembly, partial assembly (that is, a collection of parts of the assembly that are a subset of the assembly or a sub-component of the assembly), or an individual piece or part of an assembly of a building system, including: electrical; mechanical; HVAC; plumbing; fire detection and/or suppression; health and safety systems; and any other similar system. All or part of the reader may be permanently attached (that is, welded, embedded, attached with an adhesive, or using any other appropriate method) or removably attached (that is, attached with Velcro, temporary adhesive, straps, pins, bolts, other fasteners, or using any other appropriate method).

All or part of the reader may be attached to a 3D printer. The printer may be generally stationary or movable under its own or external power. One possible use of this arrangement is to have the reader provide feedback to the 3D printer based on patterns printed by the 3D printer, as discussed further below.

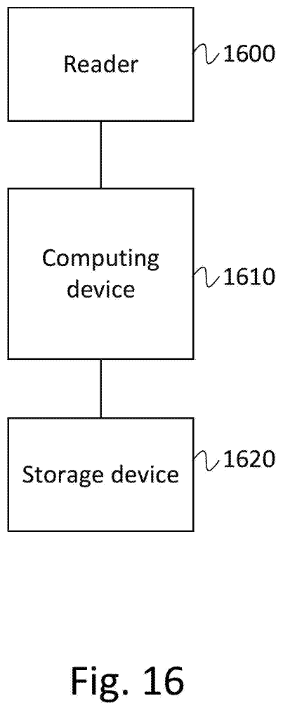

FIG. 16 is an illustration of a system comprising a reader 1600 in communication with a computing device 1610, and an optional storage device 1620. The computing device 1610 may be a mobile computing device, server, or other appropriate device or system. The computing device 1610 may be in communication with a storage device 1620, including a cloud-based storage device or any appropriate storage device. The connections between the reader 1600, computing device 1610, and/or storage device 1620 may be wired or wireless connections.

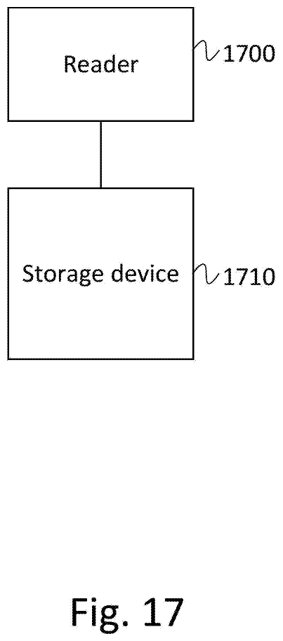

FIG. 17 is an illustration of a reader 1700 in communication with a storage device 1710. The storage device 1710 may be a cloud-based storage device or any appropriate storage device.

Any one or more of the readers, computing devices and/or storage devices in the systems discussed above may contain data that associates one or more 2D and/or 3D patterns with a memory or other storage location such that reading the pattern allows read and/or write access to the memory or storage location. This may be done by associating the one or more patterns with a URL, as is known in the art, or using any other appropriate method. The memory or storage location may contain data associated with one or more patterns. This association can be performed through a database (for example, comparing pattern data captured by the reader with a database of pattern data, identifying a database entry containing pattern data that matches the pattern data captured by the reader, and then accessing other data contained in, linked to, or otherwise associated with that database entry, including information in other databases or storage locations) or any other appropriate method as known in the art.

The data associated with a pattern may comprise security information including: directing the reader to only connect to a certain network, or a network with certain security credentials or encryption level; restricting what parts of the computing device and/or storage device may be accessed by the reader; password, token, or key information; permissions or other security measures for restricting access to information based on time or geographic location of the reader; or any other similar appropriate security measures or information.

The data associated with the patterns may be tiered or otherwise arranged in a hierarchy. By using this technique, a reader may take an initial read of a pattern at a lower resolution or using a less resource-intensive imaging technology, as discussed above, in order to obtain or identify an appropriate first level of data. After the initial read, the reader may take one or more additional reads of the pattern using increasing resolution or more resource-intensive imaging techniques in order to obtain or identify appropriate second and subsequent levels of data.

For example, a reader may take an initial reading of a multi-color 3D pattern using an RGB camera to capture a 2D image of the color pattern. A computing device in communication with the reader may use the captured 2D image of the color pattern to identify one of a plurality of geographically dispersed servers. After the initial reading and either concurrent with or subsequent to identification of the server by the computing device, the reader may take a second reading of the multi-color 3D pattern to capture a low-resolution depth image of the pattern (that is, the depth image captures the general 3D profile of the 3D pattern, but does not capture all details of the pattern). The computing device may use the captured low-resolution depth image to identify one of a plurality of databases hosted by the identified server. After the second reading and either concurrent with or subsequent to identification of either the server or database by the computing device, the reader may take a third reading of the multi-color 3D pattern to capture a higher resolution depth image of the pattern (that is, the depth image captures more details of the 3D pattern than just the general profile and may capture every detail of the 3D pattern). The computing device may use the captured higher resolution depth image to identify one of a plurality of files or storage areas of the identified database. In addition to conserving resources associated with capturing images of the pattern, as discussed above, this method reduces the time necessary to identify the appropriate resource associated with the pattern being read by eliminating the need to search every server or database for the required resource. This method can also reduce conflicts in accessing data in embodiments where multiple readers are in use simultaneously by reducing the number of computer systems accessing a particular server, database, or other storage device.

In addition, or alternatively, security information may be stored at a second or subsequent level of the pattern. Reading the second or subsequent level may require a different type of reader than that used to read the first level. Storing security information in this manner may increase security by requiring the use of multiple specific reader types in order to view the security information.

For example, a pattern may comprise a first level consisting of a 2D black and white pattern and a second level consisting of a 3D pattern similar to that shown in FIG. 12 storing security information. By using this type of pattern, an employer can make information associated with the first level of the pattern accessible to employees with a reader capable of reading a 2D black and white pattern, but restrict access to the security information on the second level to those employees with a reader capable of reading both the 2D black and white pattern and the 3D pattern.

In another example, an enterprise may create a pattern with a 2D or 3D first level pattern readable by any reader, a majority of readers, or any other desirable subset of readers and a 2D second level pattern in a certain wavelength that is only readable using a particular filter. By using this type of pattern, the enterprise may present data associated with the first level pattern to a broad audience, but restrict access to data associated with the second level pattern to users who obtain the particular filter necessary to read the second level pattern. In one embodiment, the first level pattern may be a 2D pattern printed using an ink or other substance that is visible in the visible spectrum and the second level 2D pattern may be printed on top of the first level pattern using an ink or other substance that is invisible in the visible spectrum such that the first level pattern is readable through the second level pattern until the particular filter is applied. (Note: in the case of a 3D first level pattern, the second level pattern may be printed, stamped, or otherwise applied to the surface of the 3D pattern. This type of 2D pattern may be present at different depths, but may be read independent of depth, i.e., readable by a 2D reader)

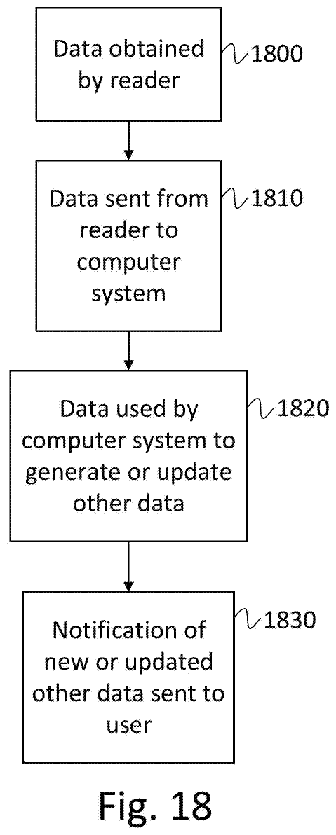

FIG. 18 is a flow chart of a method for generating or updating location information and/or associated data, the method comprising: obtaining 1800 data by a reader; sending 1810 the obtained data to a computer system; using 1820 the obtained data to generate or update location information and/or associated data; and, optionally, notifying 1830 a user of the generated or updated data. The data obtained by the reader may comprise location data of the reader, location data of pattern(s) being read, time stamp data, data relating to movement and/or orientation of the reader including velocity and acceleration data, and/or data relating to the relative location of a pattern and the reader. Location data of the reader and/or pattern may be: determined using GPS information; calculated using time, velocity, and acceleration information of the reader; determined based on relative positions of read patterns; accessed from a computing or storage device (that is, the data accessed from the computing or storage device when a pattern is read includes the location of the pattern); determined using some combination thereof; or determined using any other known, suitable means.

Data obtained by the reader may be combined with data located at a computing or storage device. The data located at a computing or storage device may comprise location and associated information related to items associated with patterns that may be read by a reader. The combined data can be used to generate or update data related to the item and/or reader including: navigation information, including route traffic, estimated time(s) of arrival, alternative routes, and other similar information; location of the reader, including absolute location and/or relative location to other readers; occupancy information; BIM data; and 2D and/or 3D modeling data, including as-built drawings. In a case where the combined data is used to update data, the updated data may be created automatically, or may require authorization by a user or other system. In addition or alternatively, an updated version of the data may be created as a branch of the non-updated data such that both updated and non-updated versions of the data are available for future use.

In one embodiment where the data being generated or updated is navigation and/or navigation-related information: the reader may read a pattern and send the read pattern information to a computing device; the computing device may access the location information associated with the pattern, such location information being stored at the computing device or at a storage device; the computing device may combine the global location of the pattern with the location of the reader relative to the pattern (the relative location being determined using one of the methods discussed above) in order to determine the global location of the reader; the global location of the reader may then be used to generate navigation information using techniques that are known in the art. This method has the benefit of providing a user with a navigation experience similar to using a GPS-based navigation system but with the benefit of not being reliant on a GPS signal. In certain embodiments, the computing device may also use inertial or other sensors, including depth cameras or other devices discussed above, to determine orientation of the reader as well as movement of the reader after the pattern is read. This method enables the orientation and/or location of the reader to be tracked after a pattern is read. In certain embodiments, the reader may read multiple patterns and the computing device may use these multiple readings to periodically update location information generated using data from inertial or other sensors as discussed above. This method enables the location of the reader to be updated continuously with periodic checks against data from the read patterns. The navigation and/or location information discussed above may be displayed to a user or used by the computing system or another computing system, as discussed further below.

In one embodiment, a plurality of readers are connected to one or more computing devices such that one or more computing devices has access to location information of the plurality of readers. The one or more computing devices may use the locations of the plurality of readers to generate composite and/or dynamic location and/or navigation information, such as real-time traffic reports, travel times based on the movement speed of readers along various routes, traffic congestion indicators, route recommendations based on the number and speed of different readers on different routes, and other similar information. In some embodiments, this information may be transmitted to one or more data aggregation locations for analysis or storage. This method enables a level of visibility of reader locations similar to an air traffic control center.

In one embodiment, a plurality of readers are connected to one or more computing devices such that one or more computing devices track which and/or how many of the plurality of readers have read one or more patterns. This information enables the computing device to track which readers have passed the locations/items associated with the patterns. This method enables the computing system to determine the number of readers occupying a given area where entering or leaving the area requires a reader to read a pattern associated with an entrance or exit. One exemplary implementation of this method is a parking garage. Vehicles with readers attached scan patterns located at entrances and exits to the garage, as well as on ramps between levels of the garage. This information is sent to one or more computing devices, one or more of which combine location data from one or more readers to determine the number of readers (and associated vehicles) on each floor of the garage. This method enables occupancy data for the garage to be posted for drivers to locate empty parking places in the garage and/or stored and aggregated for data analysis. The occupancy data may also be distributed or stored in such a way that it can be accessed by first responders or other personnel in the event of a structural collapse or other search and extraction operation. The granularity of the occupancy data can be scaled up or down by increasing or decreasing the number of patterns. For example, the granularity could be scaled up to have a pattern in each parking space such that availability of individual parking spaces is known.

In one embodiment, patterns are attached to items at known locations and information associated with an item may be accessed by scanning the associated pattern. The information associated with the item may include schematics, modeling, BIM, or other dimensional information for the item. This information can be combined with the location of the item relative to other items that have been scanned to generate as-built drawings and/or models. That is, the location of patterns attached to items may be given local coordinates relative to other scanned items and those local coordinates may be combined with the planned dimensions of the items to generate local coordinates corresponding to the planned dimensions. These local coordinates for item locations can be compared with the planned item locations in a manner similar to that discussed below, and/or converted into global coordinates.

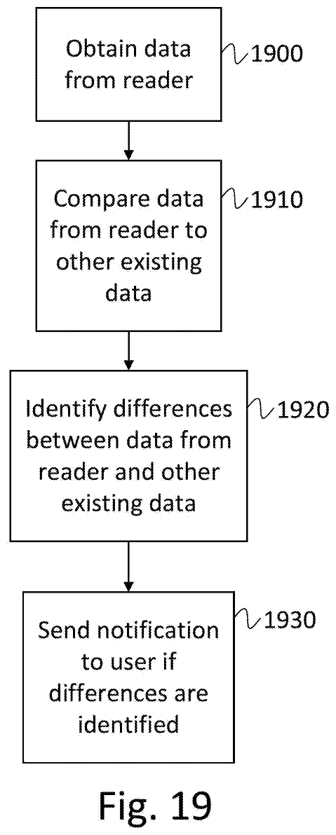

FIG. 19 is a flow chart of a method for detecting differences between data obtained by a reader and other existing data comprising: obtaining 1900 data by a reader; comparing 1910 the data obtained by the reader against other existing data; identifying 1920 differences between the data obtained by the reader and the other existing data; and, optionally, sending 1930 a notification to a user if differences are identified. The existing data may be located at a computing or storage device.

The data obtained by a reader may comprise data obtained by reading a pattern attached to or associated with an item, data related to the location of the reader, and/or data related to the location of the pattern being read. The other existing data may comprise fabricator or manufacturer information, as-designed locations, as-designed dimensions, schematics, and/or other technical data related to the item (including capacities, hazardous material data, maintenance requirements, and/or maintenance checklists). Alternatively or in addition, the other existing data may comprise location data from a GPS system.

As-built information similar to that discussed above may be compared against as-designed information to identify discrepancies. This information may include information related to the size, orientation, or location of the item, as discussed above. Alternatively or in addition, the reader may be attached to a vehicle or device comprising additional sensors to measure flow rates, capacities, magnetic or electrical fields, and/or other similar data for comparing as-built quantities or ranges to as-designed quantities or ranges.

The comparison of the obtained data to the existing data may be used to modify construction/fabrication of later-constructed items or objects to compensate for discrepancies between as-designed and as-built information. The modifications may include updating instructions for or controllers of construction/fabrication equipment, including 3D printers, formwork/formwork jacks, and other equipment as discussed above and below. Alternatively or in addition, the comparison of the obtained data to the existing data may be used to update design, construction, and/or shop drawings comprising or related to the existing data.

Alternatively or in addition, the comparison of the obtained data to the existing data may include verifying the location of items relative to other items. This verification may include reading one or more patterns on a plurality of items, determining the locations of the items relative to the reader as discussed above, and determining the locations of the items relative to each other based on the locations of the items relative to the reader. This functionality may be used to ensure that appropriate spacings or tolerances are maintained between items, including: prefabricated electrical, mechanical, and/or structural systems; items printed on site and then put in place; and/or items that are printed in place by the same or different printers.

For example, an industrial facility may require certain minimum spacings between prefabricated items. Using the functionality discussed above, a user can quickly determine if the required spacings have been obtained by using a reader to read patterns on each of the prefabricated items. Using relative locations in this manner instead of absolute or global locations eliminates the need to establish a baseline location of the reader and may reduce computational, bandwidth, and other operating overhead of the system.

In a further example, a 3D pattern mold, as discussed above, may be used to embed the same 3D pattern in a plurality of similar or identical items. A reader may use the relative positions of the plurality of identical items to determine if individual ones of the items are in the correct location. A system may determine which of the items the reader is reading a pattern from based on the position of the reader, if item-specific information is requested. This method may also be performed using 2D patterns. Using the same 2D or 3D pattern in multiple items may reduce item fabrication time as well as reducing data storage requirements and other operating overhead of the system. One example of identical items may be precast “T” sections with identical shapes and steel reinforcing layouts used to construct a parking garage or other structure. One example of similar items may be precast “T” sections with identical shapes but varying steel reinforcing layouts.

The relative position of 2D and/or 3D patterns may also be used to verify camber of structural items at various load stages, including pre-tensioned elements, post-tensioned elements, and non-tensioned elements. Camber may be measured by comparing the relative locations of a plurality of 2D or 3D patterns at various locations on an item. Camber verification of pre and post-tensioned items can be used to validate appropriate load transfer from the tensioning. Camber verification of non-tensioned items can be used to validate that the item was fabricated correctly and is appropriately supporting any applied load.

The relative position of 2D and/or 3D patterns may also be used during safety checks to identify potential material failure or equipment failure. Relative positions of 2D and/or 3D patterns associated with one or more items may be measured during and/or after construction/fabrication in order to determine if the relative positions are within a predetermined limit. Relative positions of the patterns exceeding this limit may indicate: failure of a material or connection of an item; or failure of an item itself. The predetermined limit may be set by a user or automatically based on manufacturer specifications, design codes, automated design software, or other methods.

If a reader detects patterns whose relative positions exceed the predetermined limit, a system may take any appropriate action to alert a user or others to the possibility of a safety emergency. Such actions may comprise any one or more of: sending a notification to a user; sending a notification to one or more a plurality of people on a contact roster; sending multiple messages at a predetermined time interval until a reply is received; or sending a message to one or more people on a hierarchical contact roster, and sending subsequent messages to one or more people higher up the hierarchy if a reply is not received within a predetermined time period from sending the prior message. The contact roster and/or hierarchical contact roster may comprise first responders, engineers, manufacturer representatives, rehabilitation or retrofit specialists, and/or facility owners and/or occupants. The reader may also be part of or in contact with an automated access system that restricts access to parts of a facility where the predetermined limit has been exceeded.

In an embodiment where the other existing information comprises location information from a GPS system, the GPS-based location information may be compared against location information determined from reading one or more patterns, as discussed above. If differences are detected between the GPS-based and pattern-based locations, a notification may be sent indicating that the GPS system is or has been spoofed. The notification may be sent to a user or group of users as discussed above. The difference between the GPS-based and pattern-based locations may have to exceed a threshold before a notification is set. This threshold may be set manually by a user or determined automatically based on any one or more of: speed of movement; type of movement (air, ground, water, or space-based); changes in movement (rapid or gradual changes in speed and/or direction); and strength and/or quantity of GPS signals used to generate the GPS-based location data.

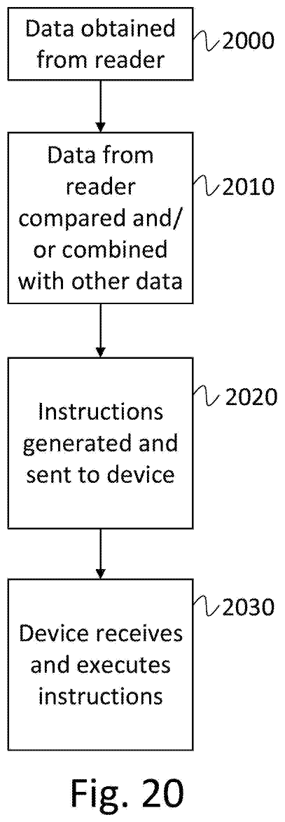

FIG. 20 is a flow chart of a method for controlling a device associated with a reader comprising: obtaining 2000 data by a reader; comparing or combining 2010 the data obtained by the reader against other data; generating 2020 instructions for the device based on the combination or comparison of data 2010, sending 2020 the instructions to the device; and, receiving and executing 2030 the instructions by the device. The other data may be located at a computing or storage device.

The data obtained by a reader may comprise data obtained by reading a pattern attached to or associated with an item, data related to the location of the reader, and/or data related to the location of the pattern being read. The other data may comprise information regarding: the identity of the item and/or person(s) associated with the item; the location of a point of interest relative to the item; the location of the item and/or reader relative to other items and/or readers; as-designed drawings, schematics, and/or technical data related to the item (as discussed above); or other data related to the item to which the pattern is attached or associated.

The device associated with the reader may comprise a mobile or stationary 3D printer, robot, manned or unmanned vehicle (including ground, air, or water based vehicles), construction equipment, or any other object that a reader may be associated with. In some embodiments, the device associated with the reader may comprise one or more propulsion systems comprising any one or more of a: rotor; wheel; track; articulating arm and/or leg; jet engine; internal combustion engine; electric motor; propeller; paddle; and paddle wheel. In some embodiments, the piece of construction equipment may comprise equipment and machinery described above including: fully or partially automated pavers, fully or partially automated formwork (including slip-form machinery), fully or partially automated painting and/or spraying machinery, and fully or partially automated inspection and/or testing equipment or machinery.

The instructions generated may comprise instructions to: move the device using global directions and/or directions relative to one or more patterns, including directions to return to a previous position; obtain a photo, video, sound, or other recording; obtain a measurement using an onboard measurement system, sending an instruction to a remote measuring system, and/or accessing a preexisting measurement; compare an obtained measurement to an existing measurement and, optionally, take further actions as discussed above; perform other action, such as deposit materials including paving materials, construction materials including concrete and any other depositable construction materials known in the art, paint, epoxy, adhesives, protective coatings, markings, reflective materials (materials may be deposited such that they form any one or more of the patterns discussed above); perform welding and/or other automatable mechanical tasks as known in the art; perform coring or otherwise retrieve samples of materials, air, water, other liquids, and/or soil; adjust the position of other objects associated with the device, such as jacking or leveling, and/or adjusting formwork such as with a slip form machine.

Instructions may be generated based on a relative position of one or more readers, devices, and/or patterns, as discussed above.

In an embodiment of the parking garage example used above comprising the use of autonomous vehicles, information regarding individual parking spaces can be used to direct vehicles to available spaces. In addition, information associated with one or more readers may include permissions to access reserved parking spaces (such as handicapped or VIP spaces) or user preferences (such as proximity to stairs, elevators, or vehicle exits) that may be considered by a computing system that directs the reader and associated autonomous vehicle to a parking space based on that reader-specific information. In some implementations, the information associated with the reader may be associated through the use of a user or vehicle profile.

In another embodiment, an unmanned and/or autonomous vehicle (such as an unmanned aerial vehicle (UAV), ground vehicle, or watercraft) may have an attached reader, onboard computing device, and an optional onboard storage device. The onboard computing and/or storage device may contain navigation or other instructions for the vehicle to execute. These instructions may include an initial instruction to control movement of the vehicle in addition to subsequent sets of instructions that may or may not be executed based on other inputs. Some of these subsequent sets of instructions may be branches of each other. That is, one instruction may be chosen instead of one or more other instructions based on one or more other inputs. For example, a UAV may be programmed to fly a particular route and to scan for readable patterns continuously or at one or more pre-determined points. Readable patterns may be placed along the UAVs flight path to enable the UAV to check its position (validate position determined through internal sensors against an external benchmark, as discussed above) or to trigger the UAV to access one or more instructions (including subsequent or branch navigation instructions, or one or more instructions to perform another action as discussed above). This method of providing instructions to an unmanned and/or autonomous vehicle enables operation of the vehicle with minimal EM signal transmission to or from the vehicle. This method also enables operation of the vehicle in areas where GPS signals are disrupted or not available due to the terrain, human activity such as jamming or other attacks on GPS systems, or for other reasons.

In another embodiment of the UAV example above, the UAV may be an armed UAV and readable patterns, including patterns embedded in fabrics, may be carried by friendly forces. These patterns, when read by the reader attached to the UAV, may trigger a “hold fire” instruction or other warning in order to prevent fratricide. In addition or alternatively, the friendly force location information may be transmitted to another location to populate force location information on a map or in some other format for a user who may or may not be associated with the UAV. Readable patterns may also be used by friendly forces to establish target reference points, either by placing the pattern at the target reference point or at a known offset from the target reference point. In some embodiments, an offset may be sent to or accessed by the computing and/or storage device associated with the UAV in response to the pattern being read. That is, reading the pattern may generate an instruction to access the offset data.

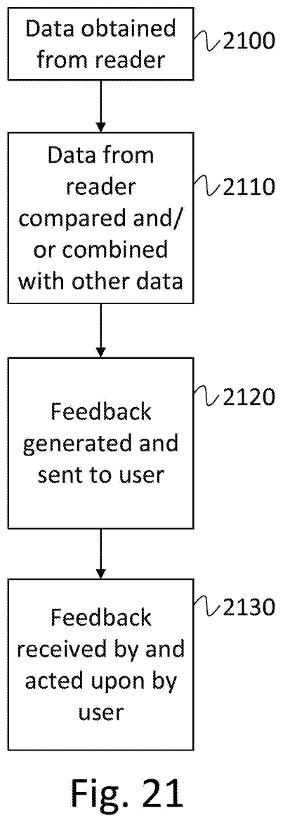

FIG. 21 is a flow chart of a method for obtaining 2100 data by a reader, combining or comparing 2110 the obtained data against data located at a computing or storage device, generating 2120 feedback for a user based on the data, providing 2120 the feedback to the user, and optionally causing the user to act on 2130 the feedback. This feedback may be used to assist the user in operating a manned or unmanned vehicle, mobile or stationary 3D printer, robot, piece of construction equipment or material, or any other object that the reader may be attached to or associated with. The feedback may be provided to the user via audio, tactile methods such as haptic feedback, and/or visual methods and may be delivered through a handheld device, wearable device, video monitor, augmented reality system, virtual reality system, or through any other known appropriate means.

Similar to embodiments discussed above regarding navigation, occupancy, testing, and targeting, this method may be used to provide navigation and related information, occupancy information, test results, comparisons, and/or friendly force and target location information to a user. That is, any of the information accessed or generated in any of the discussions of any of the embodiments in this application may be displayed to a user in order to provide the user with information and/or to elicit an action from the user. In the case of navigation information, the action from the user may be to choose one of a plurality of routes, as is known in the art. In the case of occupancy information, the action from the user may be to select a parking place or a range of possible parking places, such as by selecting a floor of a parking garage. In the case of testing and/or location comparison information, the action from the user may be to validate that the test and/or location comparison results are within an acceptable range (possibly after comparison with other data accessed by the system) or to request that an action be taken to bring future test and/or location comparison results into an acceptable range, such as redesigning and/or replacing an element of a system being evaluated. In the case of friendly force and targeting information, the action from the user may be to determine a method of engaging a target that minimizes the risk of fratricide, such as determining a path to the target, notifying the friendly forces of their proximity to the target, or determining to not attack a target based on the friendly force locations.

In another embodiment, one or more readers may be arranged to read one or more patterns associated with one or more of items such that the relative position of the items and/or readers can be communicated to a user who cannot see one or more of the items. For example, a reader may be attached to a crane and arranged to read a pattern on an item that is supposed to be moved by the crane. The location of the crane relative to the item can be determined using any of the methods discussed above and communicated to the user through a graphic display, augmented reality system, virtual reality system, or using any other known technique to aid the user in manipulating the crane such that the item can be picked up. In addition or alternatively, one or more patterns may be located at or near a location where the item being moved by the crane is to be placed. Location information may be communicated to the user, as discussed above, in order to aid the user in manipulating the crane to place the item in its desired location relative to the pattern. Although these examples have been stated in terms of operating a crane to pick up and move an item, it is understood that the techniques involved of determining relative locations and providing the location information to a user to aid the user in manipulating the items may be applied to any appropriate manipulation of any appropriate item.

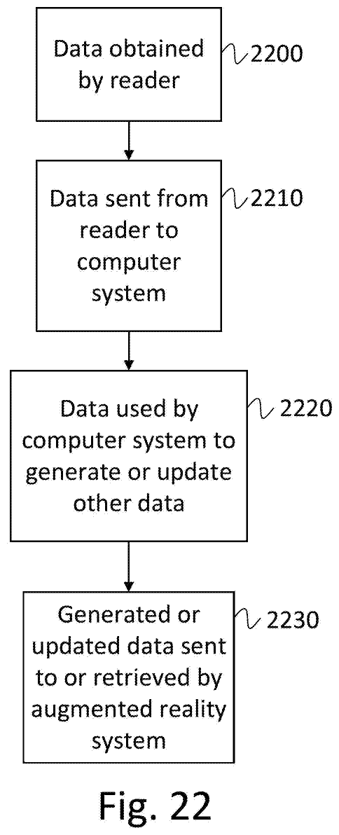

FIG. 22 is a flow chart of a method for obtaining 2200 data by a reader, sending 2210 the data to a computing device, accessing or generating 2230 additional data, and sending 2230 the accessed or generated data to an augmented reality system. In one embodiment, the accessed or additional data may be fabricator, construction, or technical data associated with an item read by the reader, such that the augmented reality system can display a virtual blueprint of the item or its surroundings. In the case of building information, this method could be used to provide a user with an augmented reality map of their surroundings, either in a first-person viewpoint or as an overhead image to facilitate user navigation. In this embodiment, the augmented reality system may also show information related to other readers that have read the same pattern. In the case where location information is compared against expected or historic locations (for example, to determine item displacements after a seismic or other event), the current location of the item can be overlaid with the expected and/or historic locations of the item. In addition or alternatively, modeling software may be accessed in order to provide estimates of other structural displacements based on any change in the location of the item and those other structural displacements and/or other associated structural information such as system loads and stresses may be displayed in the augmented reality system.

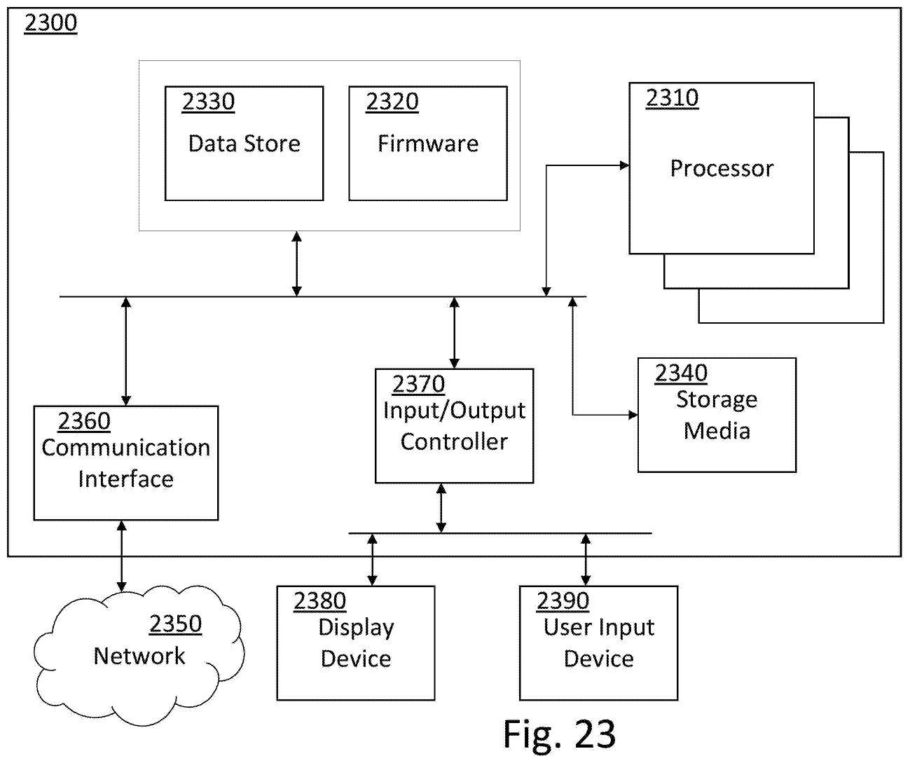

FIG. 23 illustrates various components of an exemplary computing-based device 2300 which may be implemented as any form of a computing and/or electronic device, and in which embodiments of a controller may be implemented.

Computing-based device 2300 comprises one or more processors 2310 which may be microprocessors, controllers or any other suitable type of processors for processing computer executable instructions to control the operation of the device. In some examples, for example where a system on a chip architecture is used, the processors 2310 may include one or more fixed function blocks (also referred to as accelerators) which implement a part of controlling one or more embodiments discussed above. Firmware 2320 or an operating system or any other suitable platform software may be provided at the computing-based device 2300. Data store 2330 is available to store sensor data, parameters, logging regimes, and other data.

The computer executable instructions may be provided using any computer-readable media that is accessible by computing based device 2300. Computer-readable media may include, for example, computer storage media such as memory 2340 and communications media. Computer storage media, such as memory 2340, includes volatile and non-volatile, removable and non-removable media implemented in any method or technology for storage of information such as computer readable instructions, data structures, program modules or other data. Computer storage media includes, but is not limited to, RAM, ROM, EPROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer readable instructions, data structures, program modules, or other data in a modulated data signal, such as a carrier wave, or other transport mechanism. As defined herein, computer storage media does not include communication media. Therefore, a computer storage medium should not be interpreted to be a propagating signal per se. Propagated signals may be present in a computer storage media, but signals per se, propagated or otherwise, are not examples of computer storage media. Although the computer storage media (memory 2340) is shown within the computing-based device 2300 it will be appreciated that the storage may be distributed or located remotely and accessed via a network 2350 or other communication link (e.g. using communication interface 2360).

The computing-based device 2300 also comprises an input/output controller 2370 arranged to output display information to a display device 2380 which may be separate from or integral to the computing-based device 2300. The display information may provide a graphical user interface. The input/output controller 2370 is also arranged to receive and process input from one or more devices, such as a user input device 2390 (e.g. a mouse, keyboard, camera, microphone, or other sensor). In some examples the user input device 2390 may detect voice input, user gestures or other user actions and may provide a natural user interface. This user input may be used to change parameter settings, view logged data, access control data from the device such as battery status and for other control of the device. In an embodiment the display device 2380 may also act as the user input device 2390 if it is a touch sensitive display device. The input/output controller 2370 may also output data to devices other than the display device, e.g. a locally connected printing device. The input/output controller 2370 may also connect to various sensors discussed above, and may connect to these sensors directly or through the network 2350.

The input/output controller 2370, display device 2380 and optionally the user input device 2390 may comprise NUI technology which enables a user to interact with the computing-based device in a natural manner, free from artificial constraints imposed by input devices such as mice, keyboards, remote controls and the like. Examples of NUI technology that may be provided include but are not limited to those relying on voice and/or speech recognition, touch and/or stylus recognition (touch sensitive displays), gesture recognition both on screen and adjacent to the screen, air gestures, head and eye tracking, voice and speech, vision, touch, gestures, and machine intelligence. Other examples of NUI technology that may be used include intention and goal understanding systems, motion gesture detection systems using depth cameras (such as stereoscopic camera systems, infrared camera systems, RGB camera systems and combinations of these), motion gesture detection using accelerometers/gyroscopes, facial recognition, 3D displays, head, eye and gaze tracking, immersive augmented reality and virtual reality systems and technologies for sensing brain activity using electric field sensing electrodes (EEG and related methods).

The term ‘computer’ or ‘computing-based device’ is used herein to refer to any device with processing capability such that it can execute instructions. Those skilled in the art will realize that such processing capabilities are incorporated into many different devices and therefore the terms ‘computer’ and ‘computing-based device’ each include PCs, servers, mobile telephones (including smart phones), tablet computers, set-top boxes, media players, games consoles, personal digital assistants, and many other devices.

Those skilled in the art will appreciate that software can be a valuable, separately tradable commodity. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

Any range or device value given herein may be extended or altered without losing the effect sought, as will be apparent to the skilled person.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The steps of the methods described herein may be carried out in any suitable order, or simultaneously where appropriate. Additionally, individual blocks may be deleted from any of the methods without departing from the spirit and scope of the subject matter described herein. Aspects of any of the examples described above may be combined with aspects of any of the other examples described to form further examples without losing the effect sought.

The term ‘comprising’ is used herein to mean including the method blocks or elements identified, but that such blocks or elements do not comprise an exclusive list and a method or apparatus may contain additional blocks or elements.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments and/or combine any number of the disclosed embodiments without departing from the spirit or scope of this specification.

What is claimed is:

1. A system comprising:
at least one reader;
at least one pattern;
at least one computing device in communication with the at least one reader; and
at least one vehicle arranged to be controlled based at least in part on data obtained by the at least one reader.

2. The system of claim 1, wherein the at least one reader comprises a plurality of cameras, and at least one of those cameras is of a different type than at least one other camera.

3. The system of claim 2, wherein at least one camera is arranged to capture hyperspectral imagery and at least one other camera is arranged to capture depth images.

4. The system of claim 1, wherein the at least one pattern is a 2D pattern.

5. The system of claim 1, wherein the at least one pattern is a 3D pattern.

6. The system of claim 1, wherein the at least one vehicle is an autonomous vehicle.

7. The system of claim 1, wherein the at least one vehicle is an unmanned aerial vehicle.

8. The system of claim 1, wherein the at least one vehicle is a watercraft.

9. The system of claim 1, wherein the at least one pattern is not detectable to the naked human eye.

10. The system of claim 1, wherein the at least one computing device is arranged to control the location of the at least one vehicle relative to the at least one pattern.

11. The system of claim 1, wherein the at least one pattern comprises a plurality of levels.

12. The system of claim 1, further comprising security information associated with the at least one pattern.

13. The system of claim 1, wherein the at least one computing device is arranged to access location information associated with the at least one pattern.

14. The system of claim 1, further comprising a display device arranged to display location information of a plurality of readers.

15. A method at a computing device comprising:
receiving, from at least one reader, pattern information regarding at least one pattern;
accessing information associated with the at least one pattern, the accessing being based at least in part on pattern-specific information; and
controlling at least one vehicle based at least in part on the accessed information.

16. The method of claim 15, wherein controlling the at least one vehicle comprises sending instructions to the vehicle that cause the vehicle to change its location relative to the at least one pattern.

17. The method of claim 15, wherein controlling the at least one vehicle further comprises:
sending the accessed information to at least a first user;
receiving an input from the at least first user, the input being based at least in part on the accessed information; and
controlling the at least one vehicle based at least in part on the input from the at least first user.

18. The method of claim 17, wherein the at least one pattern comprises a plurality of levels and the input from the at least first user comprises an instruction to read one or more of the plurality of levels.

19. The method of claim 17, wherein the accessed information comprises location information of the at least one pattern and the input from the at least first user comprises selecting one or more navigation instructions, the one or more navigation instructions being based at least in part on the accessed information.

20. A system comprising:
an autonomous vehicle;
at least one pattern;
at least one reader physically attached to the autonomous vehicle and arranged to read the at least one pattern;
at least one computing device in communication with the at least one reader, the computing device being arranged to:
access information associated with the at least one pattern; and
control the autonomous vehicle based at least in part on data obtained by the at least one reader.
